(19) United States
(12) Patent Application Publication
(10) Pub. No.: US 2025/0306901 A1
(43) Pub. Date: Oct. 2, 2025

(54) SOFTWARE MANAGEMENT APPARATUS

(71) Applicant: HONDA MOTOR CO., LTD., Tokyo (JP)

(72) Inventor: Siyuan BAO, Wako-shi (JP)

(21) Appl. No.: 19/058,639

(22) Filed: Feb. 20, 2025

(30) Foreign Application Priority Data
Mar. 28, 2024 (JP) 2024-054547

(51) Int. Cl. G06F 8/65

(52) U.S. Cl. CPC G06F 8/65

(57) ABSTRACT

A software management apparatus includes an information storage, a communication part, a communication controller, and a determination part. The information storage stores therein identification information and version information on software in association with each other. The communication part performs predetermined bidirectional communication with another vehicle present around an own vehicle. The communication controller causes the communication part to conduct first bidirectional communication including receiving first response information from the other vehicle related to an inquiry sent to the other vehicle about the identification information and version information on the software. The determination part determines an old-or-new status related to the version information on the software of each of the own vehicle and the other vehicle. The communication controller causes the communication part to conduct second bidirectional communication including receiving from the other vehicle second response information related to a download request for the software sent to the other vehicle.

### CROSS-REFERENCE STATEMENT

The present application is based on, and claims priority from, Japanese Patent Application Number 2024-054547, filed Mar. 28, 2024, the disclosure of which is hereby incorporated by reference herein in its entirety.

### BACKGROUND

### Technical Field

The disclosure relates to a software management apparatus that performs update management of software incorporated in an in-vehicle apparatus included in an own vehicle.

### Related Art

In recent vehicles, various pieces of software (programs) are incorporated in order to achieve functions of in-vehicle apparatuses included in the vehicles. With such software (programs), a case may arise where an issue, which had not been apparent at a development stage of a vehicle, manifests itself at a later stage requiring an improvement (reprogramming) of the software. Generally, updating (version updating) of such software is carried out by bringing the vehicle to a car dealer.

Applicant of the present application discloses an invention of a software update apparatus that is capable of executing a software update process more efficiently (see Japanese Unexamined Patent Application Publication Number 2021-012428, hereinafter “JP2021-012428A”).

A software update technique disclosed in JP2021-012428A involves carrying out communication with a server device every time a piece of software that is incorporated in an in-vehicle apparatus of an own vehicle is to be updated. As a result, it is difficult to easily update software that is incorporated in an in-vehicle apparatus of an own vehicle.

### SUMMARY

An aspect of the disclosure provides a software management apparatus that performs update management of a piece of software related to an in-vehicle apparatus of an own vehicle. The software management apparatus includes an information storage and a processor. The information storage is configured to store therein identification information and version information on the piece of software in association with each other. The processor is configured to perform predetermined bidirectional communication with another vehicle that is present around the own vehicle, conduct first bidirectional communication, the first bidirectional communication including sending an inquiry about the identification information and the version information on the piece of software to the other vehicle present around the own vehicle and receiving first response information related to the inquiry from the other vehicle, perform a comparison based on the first response information received from the other vehicle, and, when the identification information on the piece of software of the own vehicle and the identification information on a piece of software of the other vehicle match as a result of the comparison, determine an old-or-new status related to the version information on said piece of software of each of the own vehicle and the other vehicle. When, as a result of the determination of the old-or-new status, it has been determined that a version of the piece of software of the other vehicle is newer than a version of the piece of software of the own vehicle, the processor is configured to download the piece of software that the other vehicle includes by conducting second bidirectional communication. The second bidirectional communication includes sending a download request for the piece of software to the other vehicle and receiving second response information related to the download request from the other vehicle.

### BRIEF DESCRIPTION OF DRAWINGS

FIG. 1A is an explanatory diagram conceptually showing a state of use of a software management apparatus according to an embodiment of the disclosure.

FIG. 1B is a block configuration diagram showing an overview of a software management system including a software management apparatus according to an embodiment of the disclosure.

FIG. 2A is an explanatory diagram conceptually showing a communication data structure used by a communication part of a software management apparatus according to an embodiment of the disclosure.

FIG. 2B is an explanatory diagram conceptually showing, in a table format, combinations of software (SW) identification information and version information that are management information on software related to an in-vehicle apparatus of an own vehicle.

FIG. 2C is an explanatory diagram conceptually showing, in a table format, vehicle identification information for validating authenticity of another vehicle.

FIG. 3 shows a flowchart provided for explaining operation of a software management apparatus according to an embodiment of the disclosure.

FIG. 4 is an explanatory diagram conceptually showing how updating of software that is included in individual vehicles is promoted in a chain-reaction manner.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Hereinafter, a software management apparatus according to an embodiment of the disclosure will be described in detail with reference to the drawings as appropriate.

Note that in the drawings shown below, members sharing a common function or members including functions corresponding to each other are denoted by a common reference sign in principle. In addition, for convenience of description, there is a case where a member is shown schematically with a size or shape thereof modified or exaggerated.

### Overview of Software Management System 10 Including Software Management Apparatus 11

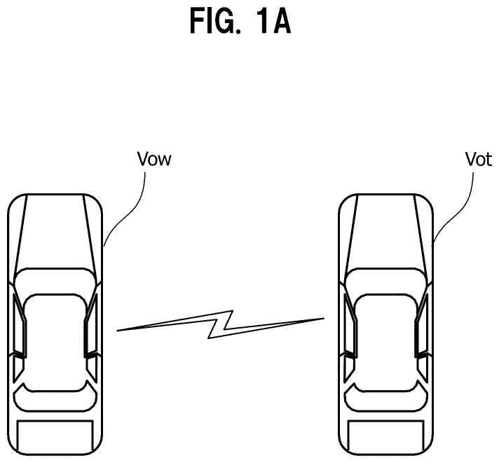

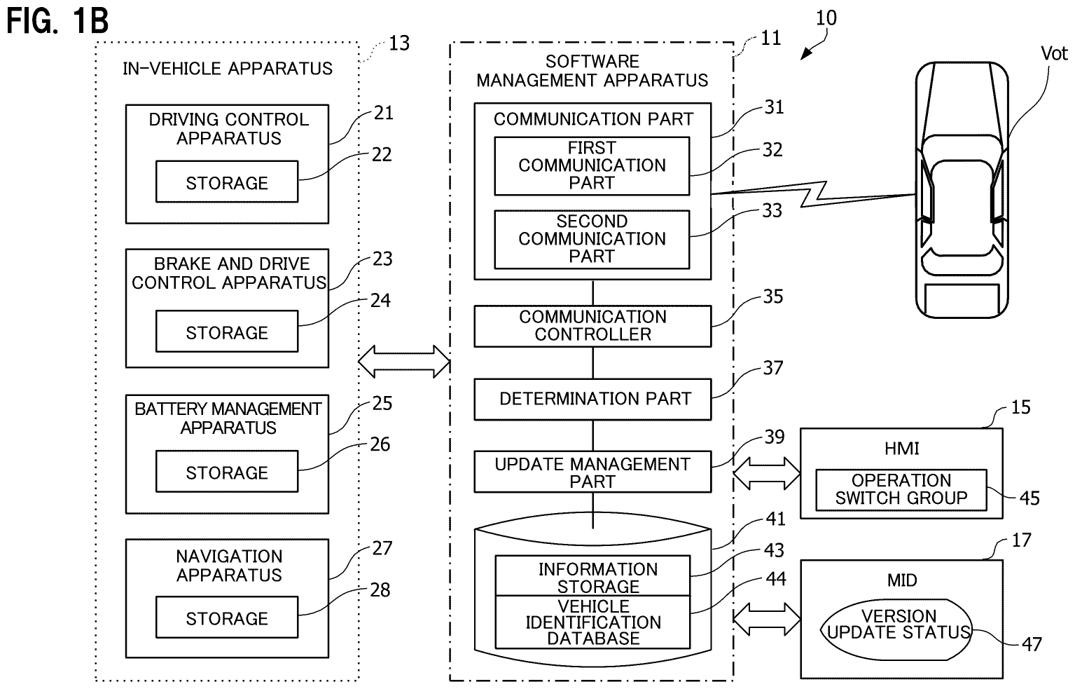

An overview of a software management system 10 that includes a software management apparatus 11 according to an embodiment of the disclosure will be given with reference to FIG. 1A and FIG. 1B.

FIG. 1A is an explanatory diagram conceptually showing a state of use of the software management apparatus 11 according to the embodiment of the disclosure. FIG. 1B is a block configuration diagram showing an overview of the software management system 10 that includes the software management apparatus 11.

As shown in FIG. 1A and FIG. 1B, an own vehicle Vow includes a function of conducting update management of a piece of software that is related to an in-vehicle apparatus 13 included in the own vehicle Vow by conducting bidirectional communication with another vehicle Vot.

The own vehicle Vow may, for example, be a vehicle such as a two-wheel, three-wheel, or four-wheel vehicle. A drive source of the own vehicle Vow may be an internal combustion engine such as a diesel engine or a gasoline engine, an electric motor, or a combination of these. The electric motor may be driven by using power generated by a power generator coupled to the internal combustion engine or by using discharged power of, for example, a fuel cell or a secondary battery such as a lithium-ion battery or a nickel-metal hydride battery.

In the description that follows, a four-wheel vehicle that uses an electric motor as a drive source will be used an example of the own vehicle Vow.

To achieve the function of conducting the update management of a piece of software that is related to an in-vehicle apparatus 13 included in the own vehicle Vow, the software management system 10 is, as shown in FIG. 1B, configured to include the software management apparatus 11, the in-vehicle apparatus 13, a human-machine interface (HMI) 15, and a multi-information display (MID) 17.

The software management apparatus 11 may be configured to include a microcomputer (not shown) that includes a central processing unit (CPU), memory such as read-only memory (ROM) and random-access memory (RAM), and an input/output interface. This microcomputer may operate by reading out and executing a program and data stored in the memory and control various functions of the software management apparatus 11.

The in-vehicle apparatus 13 is configured to include, for example, a driving control apparatus 21, a brake and drive control apparatus 23, a battery management apparatus 25, and a navigation apparatus 27.

The driving control apparatus 21 includes a function of conducting drive assistance control including automated drive (autonomous drive) control of the own vehicle Vow. The automated drive control refers, for example, to control of at least one of steering or speed of the own vehicle Vow without depending on a drive operation performed by an occupant of the own vehicle Vow.

The drive assistance control refers, for example, to control of assisting a drive operation of the occupant such as adaptive cruise control (ACC), lane keeping assist system (LKAS), Collision Mitigation Brake System (CMBS), or the like.

The driving control apparatus 21 is configured to include a microcomputer (not shown) that includes a central processing unit (CPU), memory (storage 22) such as random-access memory (RAM) and read-only memory (ROM), and an input-output interface. In the microcomputer, a predetermined piece of software for executing ACC, LKAS, or CMBS is incorporated. The microcomputer executes, for example, a corresponding control of ACC, LKAS, or CMBS by executing the predetermined piece of software.

Each piece of software is given software identification information (SW identification information) SW_id that uniquely identifies the piece of software. In addition, each piece of SW identification information SW_id is given its own version information Ver. In short, each piece of software is given its own SW identification information SW_id and version information Ver.

Each piece of software may be updated to upgrade a version thereof by an operation of the software management apparatus 11.

The storage 22 of the driving control apparatus 21 stores therein a plurality of pieces of software related to the driving control apparatus 21. The storage 22 of the driving control apparatus 21 also stores therein, for each of the plurality of pieces of software, SW identification information SW_id and version information Ver on the piece of software in association with the piece of software.

The brake and drive control apparatus 23 includes a function of performing brake and drive control of the own vehicle Vow by giving brake force, drive force, or steering force to the own vehicle Vow. The brake and drive control apparatus 23 is configured to include, for example, a brake apparatus (not shown) that causes brake torque to be output at each wheel in accordance with a brake instruction, a drive apparatus (not shown) that causes drive force (torque) to be output at drive wheels in accordance with a drive instruction, and a steering apparatus (not shown) that steers front wheels at an angle in a direction in accordance with a steering instruction.

The brake and drive control apparatus 23 is configured to include a microcomputer that includes storage 24 in the same manner as the driving control apparatus 21. In the microcomputer, predetermined pieces of software for executing brake control, drive control, and steering control are incorporated. The microcomputer executes control related to one of the brake control, drive control, or steering control or a combination thereof by executing a predetermined piece of software.

The storage 24 of the brake and drive control apparatus 23 stores therein a plurality of pieces of software related to the brake and drive control apparatus 23. The storage 24 of the brake and drive control apparatus 23 also stores therein, for each of the plurality of pieces of software, SW identification information SW_id and version information Ver on the piece of software in association with the piece of software.

The battery management apparatus 25 manages a state of a battery (not shown) that is mounted on the own vehicle Vow. The state of the battery includes a state of charge (SOC) of the battery. The battery supplies power to a drive motor (not shown) or the like. The battery management apparatus 25 includes storage 26.

The storage 26 of the battery management apparatus 25 stores therein a plurality of pieces of software related to the battery management apparatus 25. The storage 26 of the battery management apparatus 25 also stores therein, for each of the plurality of pieces of software, SW identification information SW_id and version information Ver on the piece of software in association with the piece of software.

The navigation apparatus 27 includes, for example, a Global Navigation Satellite System (GNSS) receiver (not shown). The GNSS receiver identifies a current position of the own vehicle Vow based on a signal received from a GNSS satellite. The navigation apparatus 27 includes a function of navigating a route from the current position to a destination.

The navigation apparatus 27 includes storage 28. The storage 28 of the navigation apparatus 27 stores therein a plurality of pieces of software related to the navigation apparatus 27. The storage 28 of the navigation apparatus 27 also stores therein, for each of the plurality of pieces of software, SW identification information SW_id and version information Ver on the piece of software in association with the piece of software.

The HMI 15 serves to receive various input operations made by an occupant of the own vehicle Vow. The HMI 15 is configured to include, for example, a group 45 of various operation switches and a touch panel (not shown). The touch panel may be configured integrally with the MID 17.

The MID 17 is, for example, a display apparatus including a liquid-crystal display (LCD) 47. The MID 17 serves to display an image (for example, a version update status of each of a plurality of pieces of software) generated by a display controller (not shown) included in the software management apparatus 11.

### Overview of Software Management Apparatus 11

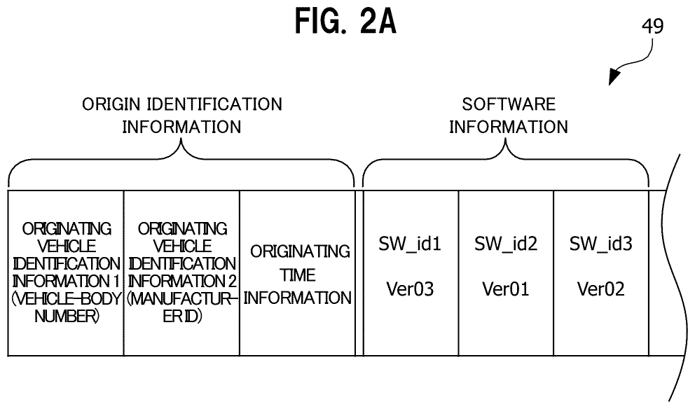

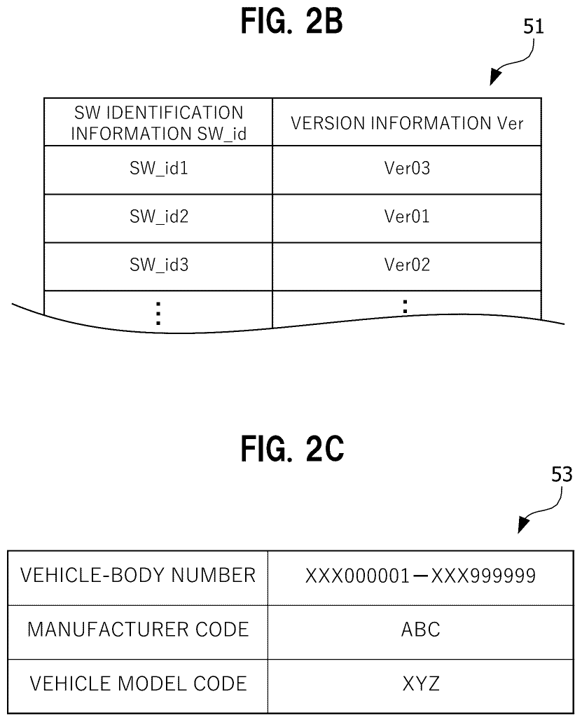

Next, an overview of the software management apparatus 11 will be described with reference to FIG. 1A, FIG. 1B, and FIG. 2A to FIG. 2C as appropriate.

FIG. 2A is an explanatory diagram conceptually showing a communication data structure used in a communication part 31 of the software management apparatus 11. FIG. 2B is an explanatory diagram conceptually showing, in a table format, combinations of the SW identification information SW_id and the version information Ver; the combinations are management information 51 on pieces of software related to the in-vehicle apparatus 13 of the own vehicle Vow. FIG. 2C is an explanatory diagram conceptually showing, in a table format, vehicle identification information 53 for validating authenticity of another vehicle Vot.

As shown in FIG. 1B, the software management apparatus 11 is configured to include, for example, the communication part 31, a communication controller 35, a determination part 37, an update management part 39, and an internal memory 41.

The communication part 31 includes a function of conducting predetermined bidirectional communication with another vehicle Vot that is present around the own vehicle Vow. The communication part 31 is configured to include a first communication part 32 that conducts first bidirectional communication with the other vehicle Vot by using a first communication method and a second communication part 33 that conducts second bidirectional communication with the other vehicle Vot by using a second communication method that is different from the first communication method.

In the second bidirectional communication related to the second communication part 33, a communication method with higher confidentiality and a higher bit rate compared to the first bidirectional communication related to the first communication part 32 is used.

In the first bidirectional communication related to the first communication part 32, the first communication part 32 conducts the first bidirectional communication with the other vehicle Vot that is present around the own vehicle Vow by using a wireless communication method such as dedicated short-range communications (DSRC) or cellular communication.

In the second bidirectional communication related to the second communication part 33, the second communication part 33 conducts the second bidirectional communication with the other vehicle Vot that is present around the own vehicle Vow by using a wireless communication method such as Wi-Fi (registered trademark) or Bluetooth (registered trademark).

The communication controller 35 causes the first communication part 32 to conduct the first bidirectional communication to send an inquiry about the SW identification information SW_id and the version information Ver on a piece of software to the other vehicle Vot present around the own vehicle Vow and to receive first response information related to the inquiry from the other vehicle Vot.

When it has been determined that a version of the piece of software of another vehicle Vot is newer than a version of the piece of software of the own vehicle Vow as a result of determination made by the determination part 37, which will be described later, the communication controller 35 causes the second communication part 33 to conduct second bidirectional communication to send a download request for the piece of software to said another vehicle Vot and to receive second response information related to the download request from said another vehicle Vot.

Here, the communication data structure (a communication frame 49) used in the first bidirectional communication and the second bidirectional communication will be described with reference to FIG. 2A.

As shown in FIG. 2A, the communication frame 49 may be configured to include origin identification information and software information.

The origin identification information may include originating vehicle identification information 1 (vehicle-body number related to an originating vehicle Vog), originating vehicle identification information 2 (manufacturer identification [manufacturer code] related to the originating vehicle Vog), and originating time information. A vehicle Vrv that receives the communication frame 49 that includes the origin identification information may find what time and from what kind of originating vehicle Vog the communication frame 49 has been received.

The software information may include the SW identification information SW_id and the version information Ver on a piece of software related to the in-vehicle apparatus 13 of the originating vehicle Vog. The software information of the communication frame 49 related to the second response information of the second bidirectional communication may include a program for updating a version of a piece of software.

The vehicle Vrv that receives the communication frame 49 that includes the software information may find the SW identification information SW_id and the version information Ver on the piece of software related to the in-vehicle apparatus 13 of the originating vehicle Vog in addition to what time and from what kind of originating vehicle Vog the communication frame 49 has been received.

The determination part 37 checks, based on the first response information received from another vehicle Vot, whether the SW identification information SW_id (Vow) on a piece of software of the own vehicle Vow and the SW identification information SW_id (Vot) on a piece of software of the other vehicle Vot match.

When, as a result of the check based on the first response information received from the other vehicle Vot, the SW identification information SW_id (Vow] on the piece of software of the own vehicle Vow and the SW identification information SW_id (Vot) on the piece of software of the other vehicle Vot is found to match, the determination part 37 determines an old-or-new status related to the version information Ver on the piece of software of each of the own vehicle Vow and the other vehicle Vot.

When the determination part 37 determines that the SW identification information SW_id (Vow) on the piece of software of the own vehicle Vow and the SW identification information SW_id (Vot) on the piece of software of the other vehicle Vot match as a result of the check based on the first response information received from the other vehicle Vot and that a version of the piece of software of the other vehicle Vot is newer than a version of the piece of software of the own vehicle Vow, the update management part 39 conducts an update to upgrade the version of the piece of software by applying the piece of software downloaded from the other vehicle Vot to the in-vehicle apparatus 13 of the own vehicle Vow.

The internal memory 41 is configured to include information storage 43 and a vehicle identification database 44.

As shown in FIG. 2B, the information storage 43 includes a function of storing therein the SW identification information SW_id and the version information Ver in association with each other as the management information 51 on the piece of software related to the in-vehicle apparatus 13 of the own vehicle Vow. An information update of stored content of the information storage 43 may be performed when, for example, an update process of the piece of software related to the in-vehicle apparatus 13 of the own vehicle Vow is conducted.

As shown in FIG. 2C, the vehicle identification database 44 includes a function of storing therein a vehicle-body number, a manufacturer code, and a vehicle model code that are given to a vehicle V. The vehicle-body number, manufacturer code, and vehicle model code of a vehicle V are stored in association with one another as vehicle identification information 53 that is used for validating the authenticity of the other vehicle Vot. An information update of stored content of the vehicle identification database 44 may be performed, for example, with an information management server (not shown) at an appropriate timing.

### Operation of Software Management Apparatus 11

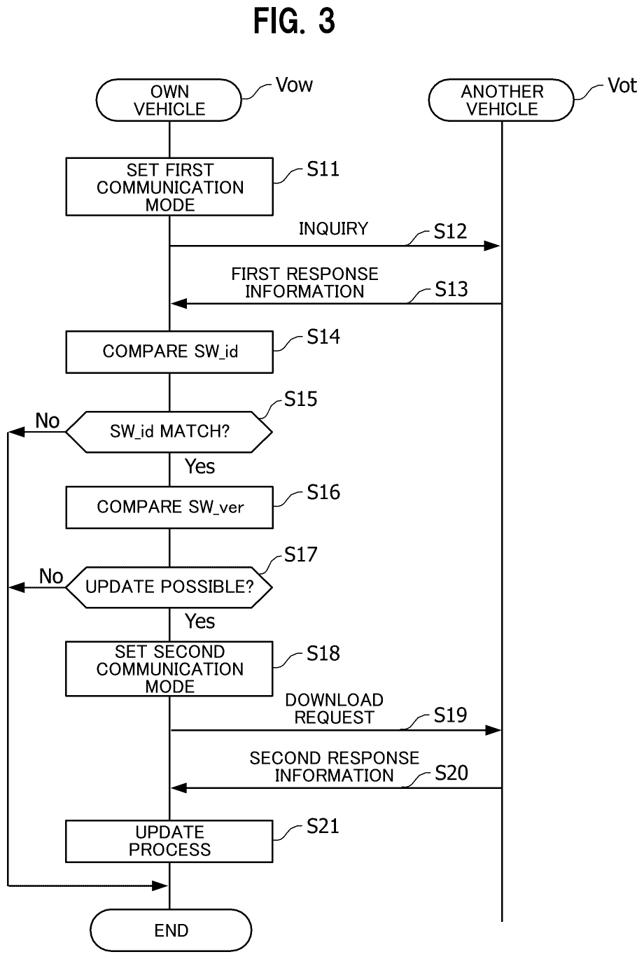

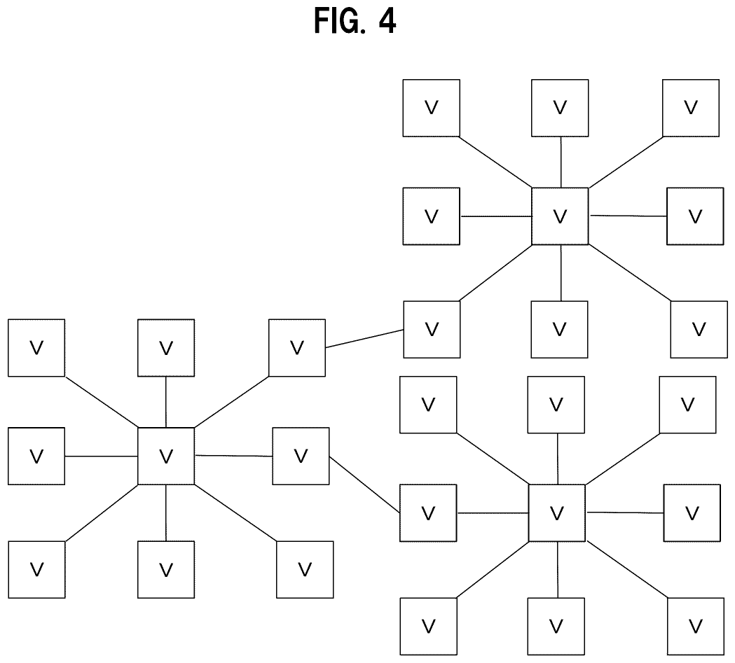

Next, an operation of the software management apparatus 11 will be described with reference to FIG. 3 and FIG. 4.

FIG. 3 shows a flowchart of a process. The flowchart of FIG. 3 is provided for explaining the operation of the software management apparatus 11. FIG. 4 is an explanatory diagram conceptually showing how updating of software included in each of a plurality of vehicles V is promoted in a chain-reaction manner.

Note that it is assumed that the software management apparatus 11 recognizes that another vehicle Vot is present around the own vehicle Vow in advance through an action of Advanced Driver-Assistance System (ADAS) of the own vehicle Vow.

In step S11 shown in FIG. 3, the communication controller 35 sets a first communication mode to effect the first bidirectional communication with the first communication part 32.

In step S12, the communication controller 35 uses the first communication part 32 to send an inquiry about SW identification information SW_id and version information Ver on a piece of software to another vehicle Vot that is present around the own vehicle Vow.

In step S13, the communication controller 35 uses the first communication part 32 to conduct the first bidirectional communication to receive first response information related to the inquiry of step 12 from the other vehicle Vot. Note that the first response information may include setting information related to a second communication mode of step S18.

In step S14, the determination part 37 checks, based on the first response information received from the other vehicle Vot, whether the SW identification information SW_id (Vow) on the piece of software of the own vehicle Vow and the SW identification information SW_id (Vot) on a piece of software of the other vehicle Vot match.

In step S15, when, as a result of the check of step S14, the SW identification information SW_id (Vow) on the piece of software of the own vehicle Vow and the SW identification information SW_id (Vot) on a piece of software of the other vehicle Vot match (Yes in step S15), the determination part 37 advances to step S16.

When, on the other hand, there is no match (No in step S15), the software management apparatus 11 ends the process.

In step S16, the determination part 37 compares version information Ver on the piece of software of the own vehicle Vow and version information Ver on the piece of software of the other vehicle Vot with each other and determines an old-or-new status related to version information Ver on the piece of software of each of the own vehicle Vow and the other vehicle Vot.

In step S17, when the version of the piece of software of the other vehicle Vot is determined to be newer than the version of the piece of software of the own vehicle Vow as a result of the comparison and determination in step S16 (Yes in step S17), the determination part 37 regards the piece of software as being capable of being updated and advances the process to step S18.

When the version of the piece of software of the other vehicle Vot is not determined to be newer than the version of the piece of software of the own vehicle Vow (No in step S17), the software management apparatus 11 ends the process.

In step S18, the communication controller 35 sets a second communication mode in accordance with the setting information related to a second communication mode included in the first response information to effect the second bidirectional communication with the second communication part 33.

In step S19, the communication controller 35 uses the second communication part 33 to send a download request for the piece of software to the other vehicle Vot.

In step S20, the communication controller 35 causes the second communication part 33 to conduct the second bidirectional communication to receive second response information related to the download request in step 19 from the other vehicle Vot.

In step S21, the update management part 39 performs an update process of upgrading the version of the piece of software by applying the piece of software downloaded from the other vehicle Vot to the in-vehicle apparatus 13 of the own vehicle Vow.

Thereafter, the software management apparatus 11 ends the process.

As described above, the software management apparatus 11 according to an embodiment of the disclosure makes it possible to promote an update of software included in each of a plurality of vehicles V anytime and anywhere in a chain-reaction manner, as if an infection spreads, as shown in FIG. 4.

### Configurations and Effects of Software Management Apparatus 11 According to the Disclosure

Next, configurations and effects of the software management apparatus 11 according to the disclosure will be described.

A first aspect of the disclosure provides a software management apparatus 11 that is predicated on a software management apparatus that performs update management of a piece of software related to an in-vehicle apparatus 13 of an own vehicle Vow.

According to the first aspect, the software management apparatus 11 includes an information storage 43, a communication part 31, a communication controller 35, and a determination part 37. The information storage 43 is configured to store therein SW identification information SW_id and version information Ver on the piece of software in association with each other. The communication part 31 is configured to perform predetermined bidirectional communication with another vehicle Vot that is present around the own vehicle Vow. The communication controller 35 is configured to cause the communication part 31 to conduct first bidirectional communication. The first bidirectional communication includes sending an inquiry about the SW identification information SW_id and the version information Ver on the piece of software to the other vehicle Vot present around the own vehicle Vow and receiving first response information related to the inquiry from the other vehicle Vot. The determination part 37 is configured to perform a comparison based on the first response information received from the other vehicle Vot and, when the SW identification information SW_id (Vow) on the piece of software of the own vehicle Vow and the SW identification information SW_id (Vot) on a piece of software of the other vehicle Vot match as a result of the comparison, determine an old-or-new status related to the version information Ver on said piece of software of each of the own vehicle Vow and the other vehicle Vot.

When it has been determined that a version of the piece of software of the other vehicle Vot is newer than a version of the piece of software of the own vehicle Vow as a result of the determination made by the determination part 37, the communication controller 35 is configured to download the piece of software that the other vehicle Vot includes by causing the communication part 31 to conduct second bidirectional communication. The second bidirectional communication includes sending a download request for the piece of software to the other vehicle Vot and receiving second response information related to the download request from the other vehicle Vot.

According to the software management apparatus 11 based on the first aspect, it is possible to provide a software management apparatus 11 that is capable of easily conducting updating of software that is incorporated in the in-vehicle apparatus 13 of the own vehicle Vow.

In addition, according to the software management apparatus 11 based on the first aspect, it is possible to provide a software management apparatus 11 that is capable of improving a smooth flow of vehicular traffic thus contributing to the development of a sustainable transportation system.

A second aspect of the disclosure provides a software management apparatus 11 that is based on the first aspect and further includes an update management part 39 configured to perform an update of upgrading a version of the piece of software by applying the piece of software that has been downloaded from the other vehicle Vot to the in-vehicle apparatus 13 of the own vehicle Vow.

According to the software management apparatus 11 based on the second aspect, because the update management part 39 performs an update of upgrading a version of the piece of software by applying the piece of software downloaded from the other vehicle Vot to the in-vehicle apparatus 13 of the own vehicle Vow, it is possible to easily conduct updating of software that is incorporated in the in-vehicle apparatus 13 of the own vehicle Vow.

A third aspect of the disclosure provides a software management apparatus 11 that is based on the first or second aspect, in which the communication part 31 includes a first communication part 32 and a second communication part 33. The first communication part 32 is configured to perform the first bidirectional communication with the other vehicle Vot by using a first communication method. The second communication part 33 is configured to perform the second bidirectional communication with the other vehicle Vot by using a second communication method that is different from the first communication method. In the second bidirectional communication related to the second communication part 33, a communication method with a higher confidentiality and a higher bit rate compared to the first bidirectional communication related to the first communication part 32 is used.

According to the software management apparatus 11 based on the third aspect, since a communication method with higher confidentiality and a higher bit rate is used in the second bidirectional communication related to the second communication part 33 compared to a communication method used in the first bidirectional communication related to the first communication part 32, it is possible to conduct a safer and faster update process of the software compared to the software management apparatus 11 based on the first or second aspect.

A fourth aspect of the disclosure provides a software management apparatus 11 that is based on the third aspect, in which at least communication data (see the communication frame 49 shown in FIG. 2A) used in the second bidirectional communication includes vehicle identification information (see the “origin identification information” of the communication frame 49 shown in FIG. 2A) that may uniquely identify the own vehicle Vow and the other vehicle Vot.

According to the software management apparatus 11 based on the fourth aspect, since at least the communication data (see the communication frame 49 shown in FIG. 2A) used in the second bidirectional communication includes the vehicle identification information (see the “origin identification information” of the communication frame 49 shown in FIG. 2A) that allows the own vehicle Vow and the other vehicle Vot to be uniquely identified, it is possible for each of the own vehicle Vow and the other vehicle Vot to find an identity of the opposite vehicle when the second bidirectional communication is conducted between the own vehicle Vow and the other vehicle Vot in addition to the effect of the software management apparatus 11 based on the third aspect.

As a result, it may be possible to secure safety when conducting the second bidirectional communication between the own vehicle Vow and the other vehicle Vot.

A fifth aspect of the disclosure provides a software management apparatus 11 that is based on the fourth aspect, in which the vehicle identification information includes a vehicle-body number and a manufacturer identification of a vehicle. The software management apparatus 11 further includes a vehicle identification database 44 that is configured to store therein the vehicle identification information of an authentic vehicle. In at least the second bidirectional communication, the communication controller 35 uses the vehicle identification information of the other vehicle Vot as an authentication key and refers to the vehicle identification database 44 to secure authenticity of the piece of software.

According to the software management apparatus 11 based on the fifth aspect, in at least the second bidirectional communication, the communication controller 35 uses the vehicle identification information of the other vehicle Vot as an authentication key and refers to the vehicle identification database 44 to secure authenticity of the piece of software. It may therefore be possible to achieve at a higher level a guarantee of safety in conducting the second bidirectional communication between the own vehicle Vow and the other vehicle Vot in comparison to the software management apparatus 11 based on the fourth aspect.

### Other Embodiments

The embodiments described above show examples in which the disclosure is embodied. Hence, the technical scope of the disclosure may not be construed in a limited manner by these embodiments. This is because the disclosure may be implemented in various forms without departing from the spirit or essential features of the disclosure.

For example, although the software management apparatus 11 according to the embodiment of the disclosure has been described by using the driving control apparatus 21, the brake and drive control apparatus 23, the battery management apparatus 25, and the navigation apparatus 27 as examples of the in-vehicle apparatus 13 of the own vehicle Vow, the disclosure is not limited to these examples. The software management apparatus 11 according to the disclosure may be applied to update management of software related to an in-vehicle apparatus 13 such as an audio apparatus, a keyless entry system, a suspension system, or an air-bag apparatus.

Further, although the software management apparatus 11 according to the embodiment of the disclosure has been described using, as the own vehicle Vow, a four-wheel vehicle with an electric motor as a drive source as an example, the disclosure is not limited to this example. It goes without saying that the software management apparatus 11 according to the disclosure may be applied to any vehicle using an internal combustion engine such as a diesel engine or a gasoline engine, an electric motor, or a combination thereof as the drive source.

An object of the disclosure is to provide a software management apparatus that is capable of easily conducting an update of software that is incorporated in an in-vehicle apparatus included in an own vehicle.

In addition, an object of the disclosure is to provide a software management apparatus that is capable of improving a smooth flow of vehicular traffic thus contributing to the development of a sustainable transportation system.

The software management apparatus according to the disclosure may enable updating of software incorporated in an in-vehicle apparatus of an own vehicle to be conducted with ease.

What is claimed is:

1. A software management apparatus that performs update management of a piece of software related to an in-vehicle apparatus of an own vehicle, comprising:
an information storage configured to store therein identification information and version information on the piece of software in association with each other; and
a processor, wherein
the processor is configured to:
perform predetermined bidirectional communication with another vehicle that is present around the own vehicle;
conduct first bidirectional communication, the first bidirectional communication including: sending an inquiry about the identification information and the version information on the piece of software to the other vehicle present around the own vehicle; and receiving first response information related to the inquiry from the other vehicle;
perform a comparison based on the first response information received from the other vehicle; and,
when the identification information on the piece of software of the own vehicle and the identification information on a piece of software of the other vehicle match as a result of the comparison, determine an old-or-new status related to the version information on said piece of software of each of the own vehicle and the other vehicle, wherein
when, as a result of the determination of the old-or-new status, it has been determined that a version of the piece of software of the other vehicle is newer than a version of the piece of software of the own vehicle, the processor is configured to download the piece of software that the other vehicle includes by conducting second bidirectional communication, and wherein
the second bidirectional communication includes:
sending a download request for the piece of software to the other vehicle, and
receiving second response information related to the download request from the other vehicle.

2. The software management apparatus according to claim 1, wherein
the processor is configured to perform an update of upgrading a version of the piece of software by applying the piece of software that has been downloaded from the other vehicle to the in-vehicle apparatus of the own vehicle.

3. The software management apparatus according to claim 1, wherein
the processor is configured to:
perform the first bidirectional communication with the other vehicle by using a first communication method; and
perform the second bidirectional communication with the other vehicle by using a second communication method that is different from the first communication method, and wherein
in the second bidirectional communication, a communication method with a confidentiality and a bit rate that are higher compared to the first bidirectional communication is used.

4. The software management apparatus according to claim 3, wherein
at least communication data used in the second bidirectional communication includes vehicle identification information that may uniquely identify the own vehicle and the other vehicle.

5. The software management apparatus according to claim 4, wherein
the vehicle identification information includes a vehicle-body number and a manufacturer identification of a vehicle,
the software management apparatus further comprises a database that is configured to store therein the vehicle identification information of an authentic vehicle, and
in at least the second bidirectional communication, the processor is configured to use the vehicle identification information of the other vehicle as an authentication key and refer to the database to secure authenticity of the piece of software.
